(19) United States
(12) Patent Application Publication
(10) Pub. No.: US 2014/0112410 A1
(43) Pub. Date: Apr. 24, 2014

(54) System for Virtual Interference Alignment

(71) Applicants: TOYOTA JIDOSHA KABUSHIKI KAISHA, Toyota-shi (JP); TOYOTA INFOTECHNOLOGY CENTER CO., LTD., Tokyo (JP)

(72) Inventor: Akihisa Yokoyama, Cupertino, CA (US)

(73) Assignees: TOYOTA INFOTECHNOLOGY CENTER CO., LTD., Tokyo (JP); TOYOTA JIDOSHA KABUSHIKI KAISHA, Toyota-shi (JP)

(21) Appl. No.: 13/658,550

(22) Filed: Oct. 23, 2012

(51) Int. Cl. H04B 15/00

(52) U.S. Cl. 375/285

(57) ABSTRACT

A system and method for realizing virtual interference alignment. The system comprises a retrieving module, a determination module and a precoding module. The retrieving module retrieves source data. The determination module receives shared data and transmission information. The shared data and transmission information are generated from a shared signal received from one or more participating communication systems associated with a first virtual transmitting group. The precoding module calculates a precoding vector describing one or more requirements of interference alignment based at least in part on the transmission information. The precoding module generates a first transmission signal based at least in part on the precoding vector, the source data and the shared data.

### BACKGROUND

The specification relates to interference alignment systems. In particular, the specification relates to a system and method for realizing virtual interference alignment by sharing data for transmission between communication systems.

Interference alignment is a technology to inhibit interference on a receiving communication system. By applying this technology, each transmitting communication system controls its transmission signals in order to align interference components such that the interference components can be eliminated by the receiving communication system.

Existing interference alignment systems have numerous problems. For example, in these systems, each communication system has a limited number of antennas. As a result, these systems struggle to achieve stable communication.

### SUMMARY OF THE INVENTION

The specification overcomes the deficiencies and limitations of the prior art at least in part by providing a system and method for realizing virtual interference alignment. The system comprises a retrieving module, a determination module and a precoding module. The retrieving module retrieves source data. The determination module is communicatively coupled to the retrieving module. The determination module receives shared data and transmission information. The shared data and transmission information are generated from a shared signal received from one or more participating communication systems associated with a first virtual transmitting group. The precoding module is communicatively coupled to the determination module and the retrieving module. The precoding module calculates a precoding vector describing one or more requirements of interference alignment based at least in part on the transmission information. The precoding module generates a first transmission signal based at least in part on the precoding vector, the source data and the shared data.

### BRIEF DESCRIPTION OF THE DRAWINGS

The specification is illustrated by way of example, and not by way of limitation in the figures of the accompanying drawings in which like reference numerals are used to refer to similar elements.

FIG. 1 is a block diagram illustrating a system for realizing virtual interference alignment according to one embodiment.

FIG. 2 is a block diagram illustrating a communication system including a communication node in detail according to one embodiment.

FIG. 3 is a block diagram illustrating a transmitter module according to one embodiment.

FIG. 4 is a block diagram illustrating a storage device according to one embodiment.

FIG. 5 is a flow diagram illustrating a method for generating transmission signals according to one embodiment.

FIG. 6 is a flow diagram illustrating a method for generating transmission signals according to another embodiment.

FIG. 7 is a flow diagram illustrating a method for receiving transmission signals according to one embodiment.

### DETAILED DESCRIPTION OF THE PREFERRED EMBODIMENTS

A system and method for realizing virtual interference alignment is described below. In the following description, for purposes of explanation, numerous specific details are set forth in order to provide a thorough understanding of the specification. It will be apparent, however, to one skilled in the art that the embodiments can be practiced without these specific details. In other instances, structures and devices are shown in block diagram form in order to avoid obscuring the specification. For example, the specification is described in one embodiment below with reference to user interfaces and particular hardware. However, the description applies to any type of computing device that can receive data and commands, and any peripheral devices providing services.

Reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The specification also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, compact disc read-only memories (CD-ROMs), magnetic disks, read-only memories (ROMs), random access memories (RAMs), erasable programmable read-only memories (EPROMs), electrically erasable programmable read-only memories (EEPROMs), magnetic or optical cards, flash memories including universal serial bus (USB) keys with non-volatile memory or any type of media suitable for storing electronic instructions, each coupled to a computer system bus.

Some embodiments can take the form of an entirely hardware embodiment, an entirely software embodiment or an embodiment containing both hardware and software elements. A preferred embodiment is implemented in software, which includes but is not limited to firmware, resident software, microcode, etc.

Furthermore, some embodiments can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the specification is not described with reference to any particular programming language. It will be appreciated that a variety of programming languages may be used to implement the teachings of the various embodiments as described herein.

### System Overview

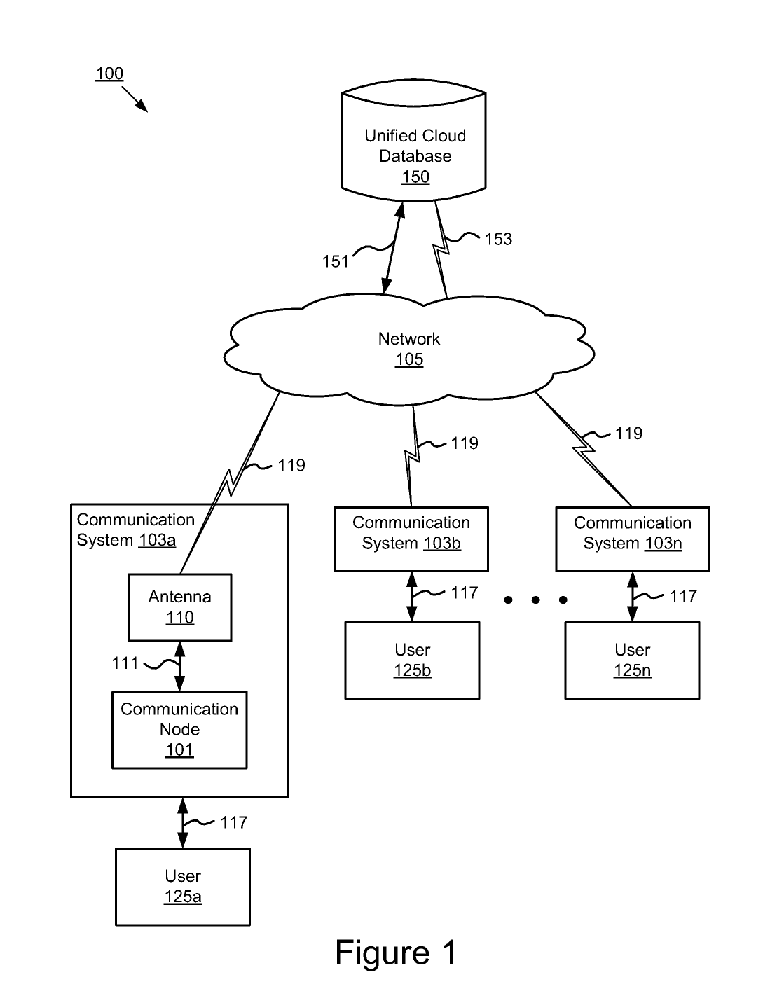

FIG. 1 illustrates a block diagram of a system 100 for realizing virtual interference alignment according to one embodiment. The illustrated system 100 includes communication systems 103a, 103b, 103n (referred to individually or collectively as communication systems 103) that are accessed by users 125a, 125b, 125n (also referred to collectively or individually as users 125) and a unified cloud database 150. In the illustrated embodiment, the communication systems 103 and the unified cloud database 150 are communicatively coupled via a network 105. For example, the communication systems 103 are communicatively coupled to one another via the network 105 to facilitate transmitting and receiving information (e.g., traffic information) between users 125 of the communication systems 103.

Although three communication systems 103a, 103b, 103n and one unified cloud database 150 are illustrated in FIG. 1, persons having ordinary skill in the art will recognize that any number of communication systems 103 and unified cloud databases 150 can be communicatively coupled to the network 105. Furthermore, while only one network 105 is coupled to the communication system 103 and the unified cloud database 150, persons having ordinary skill in the art will appreciate that any number of network 105 can be connected to the communication system 103 and the unified cloud database 150.

The network 105 is a conventional type, wired or wireless, and may have any number of configurations such as a star configuration, token ring configuration or other configurations known to those skilled in the art. Furthermore, the network 105 may comprise a local area network (LAN), a wide area network (WAN) (e.g., the Internet), and/or any other interconnected data path across which multiple devices may communicate. In yet another embodiment, the network 105 may be a peer-to-peer network. The network 105 may also be coupled to or include portions of a telecommunications network for sending data in a variety of different communication protocols. For example, the network 105 is a 3G network or a 4G network. In yet another embodiment, the network 105 includes Bluetooth communication networks or a cellular communications network for sending and receiving data such as via short messaging service (SMS), multimedia messaging service (MMS), hypertext transfer protocol (HTTP), direct data connection, WAP, e-mail, etc. In yet another embodiment, all or some of the links in the network 105 are encrypted using conventional encryption technologies such as secure sockets layer (SSL), secure HTTP and/or virtual private networks (VPNs).

In the illustrated embodiment, the unified cloud database 150 is communicatively coupled to the network 105 via signal line 151 and signal line 153 (wirelessly). The communication system 103a is communicatively coupled to the network 105 via signal line 119 (wirelessly). The user 125a interacts with the communication system 103a as represented by signal line 117. Communication systems 103b, 103n and users 125b, 125n are coupled and interface in a similar manner respectively.

The communication system 103 is any system for transmitting and/or receiving information to and from other communication systems 103. The communication system 103 exchanges information with other communication systems 103 via a network 105. The communication system 103 that transmits signals in a communication scenario is referred as to a transmitting communication system 103. The communication system 103 that receives signals in a communication scenario is referred as to a receiving communication system 103. In one embodiment, the communication system 103 works either as a receiving communication system 103 or a transmitting communication system 103 coupled to a network 105. In another embodiment, the communication system 103 works as both a receiving communication system 103 and a transmitting communication system 103 coupled to a network 105.

In one embodiment, the communication system 103 is embedded in a vehicle. In another embodiment, the communication system 103 is included in a roadside station. For example, a communication system 103 in a vehicle exchanges information (e.g., safety warnings and traffic information) with communication systems 103 in other vehicles.

In the illustrated embodiment, the communication system 103a includes an antenna 110 and a communication node 101. The antenna 110 is communicatively coupled to the communication node 101 via signal line 111. Although the antenna 110 and the communication node 101 are shown in reference to the communication system 103a, persons having ordinary skill in the art will recognize that any communication system 103 may comprise these elements. The antenna 110 is communicatively coupled to the network 105 via signal line 119 (wirelessly).

The unified cloud database 150 is an online database accessible from the network 105. For example, the unified cloud database 150 is a database where data is stored on multiple virtual servers hosted by different companies. In one embodiment, the unified cloud database 150 stores any data for providing the functionality of the system 100. In another embodiment, the unified cloud database 150 stores data received from a plurality of communication systems 103 embedded in, for example, a plurality of vehicles, roadside stations, etc.

### Communication Node 101

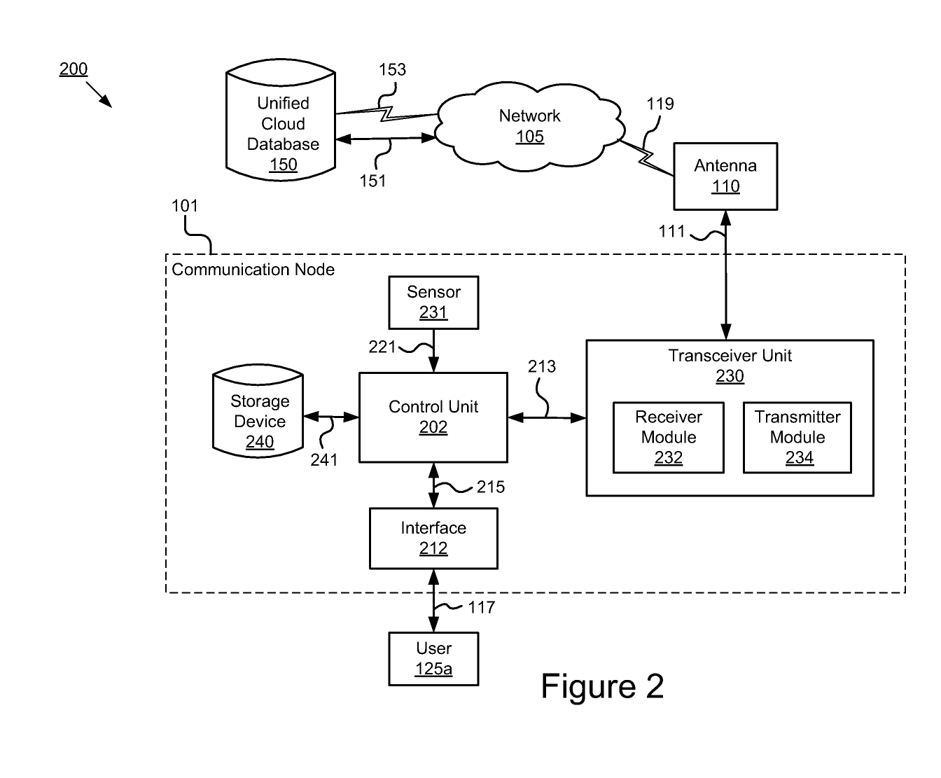

Referring now to FIG. 2, an embodiment 200 of the communication system 103 showing the communication node 101 is illustrated. The illustrated communication node 101 includes a control unit 202, a sensor 231, an interface 212, a storage device 240 and a transceiver unit 230. Although only one sensor 231, one control unit 202, one interface 212, one storage device 240 and one transceiver unit 230 are depicted in FIG. 2, persons having ordinary skill in the art will recognize that the communication node 101 can include any number of sensors 231, control units 202, interfaces 212, storage devices 240 and transceiver units 230. Furthermore, persons having ordinary skill in the art will also appreciate that the communication node 101 may include other entities not shown in FIG. 2 such as a camera, an input device, etc.

In the illustrated embodiment, the sensor 231 is communicatively coupled to the control unit 202 via signal line 221. The interface 212 is communicatively coupled to the control unit 202 via signal line 215. The user 125a interacts with the interface 212 as represented by signal line 117. The storage device 240 is communicatively coupled to the control unit 202 via signal line 241. The transceiver unit 230 is communicatively coupled to the control unit 202 via signal line 213. The transceiver unit 230 is communicatively coupled to the antenna 110 via signal line 111.

The communication node 101 is any device that transmits signals and processes received signals. For example, the communication node 101 includes a Dedicated Short Range Communications (DSRC) device. In one embodiment, the communication node 101 is embedded in a vehicle. In another embodiment, the communication node 101 is included in a roadside station.

In one embodiment, the communication node 101 transmits and receives signals to and from the antenna 110. The antenna 110 transmits and receives signals wirelessly to and from the network 105. In one embodiment, the communication node 101 in a vehicle transmits and receives signals to and from communication nodes 101 in other vehicles via the network 105. In another embodiment, the communication node 101 in a vehicle transmits and receives signals to and from communication nodes 101 included in roadside stations.

The control unit 202 is any processor-based computing device. For example, the control unit 202 is an electronic control unit (“ECU”) implemented in a vehicle. In one embodiment, the control unit 202 is implemented using a single integrated circuit such as a system-on-chip (SOC).

In one embodiment, the control unit 202 receives one or more sensor signals from the sensor 231. The control unit 202 processes the one or more sensor signals and generates source data based on the processed sensor signals. For example, the source data is any information that is useful to vehicles such as data describing velocity of the vehicle, steering angle of a steering device (not pictured), brake angle, a traffic condition, a safety warning, a road condition, a status and/or an action of a vehicle, etc. A status of a vehicle can be driving normally or out of control. An action of a vehicle can be accelerating, changing lanes, exiting a highway, etc. In one embodiment, the control unit 202 transmits the source data to the storage device 240 for storage. In yet another embodiment, the control unit 202 transmits the source data to the unified cloud database 150 for storage via the transceiver unit 230. In another embodiment, the control unit 202 transmits the source data to the transceiver unit 230 to provide the source data to communication systems 103 in other vehicles.

In one embodiment, the control unit 202 receives incoming data from the transceiver unit 230. For example, one or more signals are received from communication systems 103 in a roadside station via the transceiver unit 230. The transceiver unit 230 processes the received one or more signals to generate incoming data. The control unit 202 then stores the incoming data in the storage device 240. In one embodiment, the control unit 202 transmits the incoming data to the unified cloud database 150 for storage via the transceiver unit 230. For example, incoming data includes data describing a traffic condition, a safety warning, a road condition, a status and/or action of a vehicle, etc.

In one embodiment, the control unit 202 receives shared data from the transceiver unit 230. For example, one or more shared signals are received from communication systems 103 in other vehicles, via the transceiver unit 230. The transceiver unit 230 processes the one or more shared signals to generate shared data. The control unit 202 then stores the shared data in the storage device 240. The shared data includes, for example, data describing a traffic condition, a safety warning, a road condition, a status and/or action of a vehicle, etc. In one embodiment, the shared data received from a communication system 103 in another vehicle is transmitted to a communication system 103 in a roadside station.

In one embodiment, the control unit 202 generates graphical data for displaying the received incoming data to a user 125 through the interface 212. For example, the control unit 202 receives incoming data describing that there is a dense fog ahead. The control unit 202 then generates graphical data for displaying the incoming data as a message reading “Be cautious, there is a dense fog ahead” on the interface 212 to a user 125 such as a driver. In other examples, the control unit 202 notifies a user 125 of incoming data using a voice prompt.

In one embodiment, the control unit 202 comprises, among other things, a processor (not pictured). In another embodiment, the control unit 202 includes other components conventional to a control unit such as a memory (not pictured) and an I/O interface (not pictured).

The processor (not pictured) comprises an arithmetic logic unit, a microprocessor, a general purpose controller or some other processor array to perform computations, retrieve data stored on the storage device 240, etc. The processor processes data signals and may comprise various computing architectures including a complex instruction set computer (CISC) architecture, a reduced instruction set computer (RISC) architecture, or an architecture implementing a combination of instruction sets. The processing capability of the processor may be limited to supporting the display of images and the capture and transmission of images. The processing capability of the processor might be enough to perform more complex tasks, including various types of feature extraction and sampling. It will be obvious to one skilled in the art that other processors, operating systems, sensors, displays and physical configurations are possible.

The transceiver unit 230 is any computing device for generating transmission signals based at least in part on source data and shared data and processing signals received from the antenna 110. In the illustrated embodiment, the transceiver unit 230 comprises a receiver module 232 and a transmitter module 234. Although one receiver module 232 and one transmitter module 234 are depicted with reference to the transceiver unit 230, persons having ordinary skill in the art will recognize that the transceiver unit 230 can include any number of receiver modules 232 and transmitter modules 234.

The receiver module 232 is code and routines for processing one or more received signals. For example, the receiver module 232 converts a radio signal from a modulated radio wave into usable information such as audio, video and other data. In one embodiment, the receiver module 232 is implemented using hardware such as field-programmable gate array (FPGA) or an application-specific integrated circuit (ASIC). In another embodiment, the receiver module 232 is implemented using a combination of hardware and software.

In one embodiment, the receiver module 232 converts a received signal into incoming data. For example, the receiver module 232 receives one or more radio signals from the network 105 via the antenna 110. The one or more radio signals are transmitted by another communication system 103 included in a roadside station. The receiver module 232 processes a received radio signal by demodulating and/or decoding the received radio signal. The receiver module 232 then determines usable information based at least in part on the processed radio signal. The receiver module 232 generates incoming data using the usable information. For example, incoming data includes data describing a traffic condition, a safety warning, a road condition, a status and/or action of a vehicle, etc. The receiver module 232 sends the incoming data to the control unit 202.

In one embodiment, the receiver module 232 eliminates one or more interference signals from received signals. For example, the received signals include one or more interference signals and a desired signal. The one or more interference signals fall into a signal subspace that is different from the signal subspace of the desired signal. Therefore the receiver module 232 differentiates the one or more interference signals from the desired signal. The receiver module 232 then removes the one or more interference signals from the received signals. For example, the receiver module 232 removes the one or more interference signals from the received signals by filtering all signals in the signal subspace where the one or more interference signals are. The receiver module 232 then obtains the desired signal. In one embodiment, the receiver module 232 generates incoming data based on the desired signal.

In one embodiment, the signals received by the receiver module 232 are shared signals. For example, the receiver module 232 of communication system 103a receives a shared signal that is transmitted by a communication system 103b in another vehicle that passed by. The receiver module 232 processes the shared signal by demodulating and/or decoding the shared signal. The receiver module 232 then generates shared data from the processed shared signal. The shared data includes, for example, data describing a traffic condition, a safety warning, a road condition, a status and/or action of a vehicle, etc.

In one embodiment, the receiver module 232 also generates transmission information from the processed shared signal. The transmission information includes data describing one or more conditions to transmit the shared data. In another embodiment, the receiver module 232 also generates one or more signal descriptors from the processed shared signal. The one or more signal descriptors include data describing the shared signal received from another communication system. The one or more signal descriptors include, for example, the signal strength of the received shared signal, a distance, etc. The distance in the above example, is the distance between the communication system 103a (that includes the determination module 305) and the communication system 103b from which the shared signal was received.

In one embodiment, the receiver module 232 sends the shared data, transmission information and signal descriptors to the control unit 202. The control unit 202 stores the shared data, the transmission information and the signal descriptors in the storage device 240. In one embodiment, the receiver module 232 also sends the shared data, the transmission information and the signal descriptors to the transmitter module 234.

The transmitter module 234 is code and routines for generating one or more transmission signals. For example, the transmitter module 234 generates radio signals. The transmitter module 234 sends the radio signals to the antenna 110 for transmitting the radio signals to the network 105. In one embodiment, the transmitter module 234 is implemented using hardware such as field-programmable gate array (FPGA) or an application-specific integrated circuit (ASIC). In another embodiment, the transmitter module 234 is implemented using a combination of hardware and software.

In one embodiment, the transmitter module 234 generates one or more transmission signals based on the source data and the shared data. For example, the transmitter module 234 receives the source data from the control unit 202. The transmitter module 234 also receives shared data, transmission information and signal descriptors from the receiver module 232. In this example, the receiver module 232 receives the shared signal from a communication system 103b in another vehicle. The transmitter module 234 determines whether the signal descriptors meet one or more requirements of a virtual transmitting group. If the signal descriptors meet one or more requirements, the transmitter module 234 generates a virtual transmitting group including the communication system 103a (including the transmitter module 234) and the communication system 103b.

Once the virtual transmitting group is generated, the transmitter module 234 processes the source data and the shared data by modulating and/or encoding the source data and the shared data. The transmitter module 234 then generates one or more transmission signals based on the processed source data and shared data. In one embodiment, the transmitter module 234 sends the one or more transmission signals to the network 105 through the antenna 110. In another embodiment, the transmitter module 234 also sends the one or more transmission signals to the storage device 240 for storage via the control unit 202.

In one embodiment, the transmitter module 234 determines one or more requirements of interference alignment. For example, a requirement for interference alignment is a constraint so that all interference signals will be aligned into a signal subspace that is different from the signal subspace of the desired signal at a receiving communication system 103. In this embodiment, the transmitter module 234 calculates one or more precoding vectors based at least in part on the one or more requirements for interference alignment and the transmission information. The transmitter module 234 then generates one or more transmission signals based at least in part on the one or more precoding vectors, the shared data, and the source data.

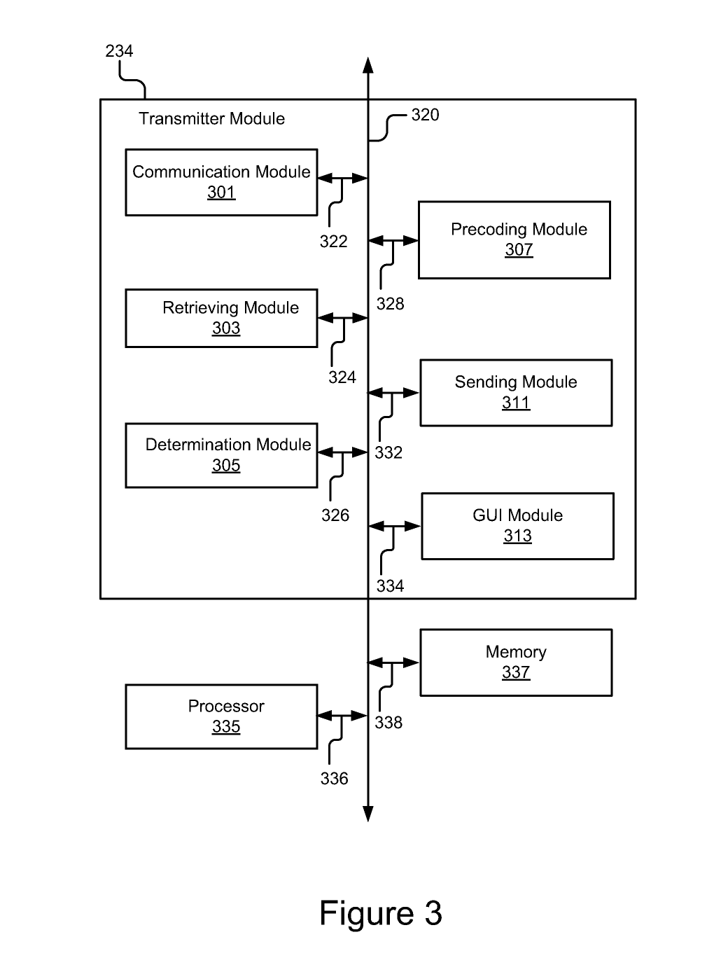

The transmitter module 234 is described below in more detail with reference to FIG. 3.

The sensor 231 is any type of conventional sensor configured to collect any type of data. For example, the sensor 231 is one of the following: a light detection and ranging (LIDAR) sensor; an infrared detector; a motion detector; a thermostat; and a sound detector, etc. Persons having ordinary skill in the art will recognize that other types of sensors are possible. In one embodiment, the sensor 231 measures a condition related to a vehicle. The sensor 231 generates a sensor signal describing the condition based on the measurement. For example, the sensor 231 measures one of a steering angle, a brake angle, a velocity, an acceleration and/or deceleration of a vehicle, a temperature inside a vehicle, whether fog lights are on and whether windshield wipers are activated, etc. The sensor 231 generates a sensor signal describing the measurement. In another embodiment, the sensor 231 measures a condition in an environment that is external to the vehicle and generates a sensor signal describing the measurement. For example, the sensor 231 measures a percentage of humidity in an environment and generates a sensor signal describing the measurement. The sensor 231 sends the sensor signal to the control unit 202.

In one embodiment, the communication node 101 includes a combination of different types of sensors 231. For example, the communication node 101 includes a first sensor 231 for monitoring a steering angle of a steering device in a vehicle, a second sensor 231 for monitoring a velocity of the vehicle and a third sensor 231 for monitoring a brake angle of a brake device in the vehicle.

In one embodiment, the communication node 101 also includes a camera (not pictured) coupled to the sensor 231. The camera is an optical device for recording images. For example, the camera takes pictures of roads, traffic lights, vehicles, pedestrians crossing the road, etc., external to a vehicle as the vehicle is driven down a road. In one embodiment, the camera is mounted in the front of a vehicle. In other embodiments, the camera is mounted on other portions of the vehicle. In one embodiment, the camera is configured to capture a video including successive frames that describe an environment surrounding a road when a driver is driving a vehicle on the road. The camera sends the images to the control unit 202 via the sensor 231. The control unit 202 then generates source data (such as traffic and safety information) based at least in part on the images.

The interface 212 is a device configured to handle communications between the user 125 and the control unit 202. For example, the interface 212 includes one or more of an in-vehicle touch screen for receiving inputs from the user 125 and a microphone for capturing voice inputs from the user 125. The interface 212 sends the inputs from the user 125 to the control unit 202. In one embodiment, the interface 212 is configured to transmit an output from the control unit 202 to the user 125. For example, the interface 212 includes an audio system for playing a voice prompt to the user 125 indicating a safety warning. In other examples, the interface 212 includes a display device for displaying a road condition to the user 125. One having ordinary skill in the art will recognize that the interface 212 may include other types of devices for providing the functionality described herein.

The user 125a is a human user. In one embodiment, the user 125a is a driver driving a vehicle on a road. The user 125a interacts with, or otherwise provides an input to, an interface 212, which sends and receives different types of data to and from the control unit 202. For example, the interface 212 is a touch screen and the user 125a touches a portion of the touch screen with a finger or a stylus to provide an input.

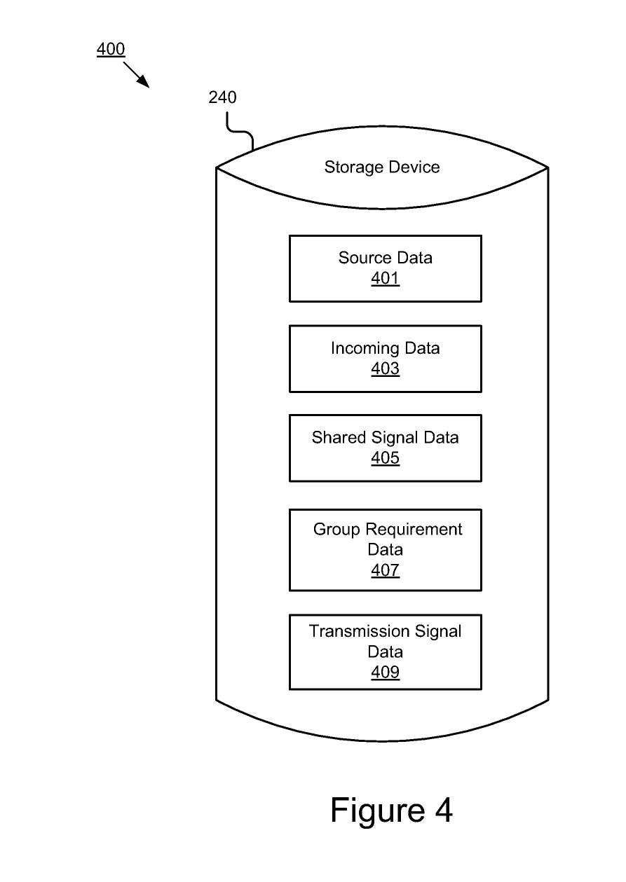

The storage device 240 is a non-transitory memory that stores data. For example, the storage device 240 is a dynamic random access memory (DRAM) device, a static random access memory (SRAM) device, flash memory or some other memory device known in the art. In one embodiment, the storage device 240 also includes a non-volatile memory or similar permanent storage device and media such as a hard disk drive, a floppy disk drive, a compact disc read only memory (CD-ROM) device, a digital versatile disc read only memory (DVD-ROM) device, a digital versatile disc random access memories (DVD-RAM) device, a digital versatile disc rewritable (DVD-RW) device, a flash memory device, or some other non-volatile storage device known in the art. The storage device 240 is described below in more detail with reference to FIG. 4.

### Transmitter Module 234

Referring now to FIG. 3, a transmitter module 234 is shown in more detail. FIG. 3 is a block diagram illustrating a transmitter module 234 according to one embodiment. The transmitter module 234 comprises a communication module 301, a retrieving module 303, a determination module 305, a precoding module 307, a sending module 311 and a graphical user interface (GUI) module 313. These components of the transmitter module 234 are communicatively coupled to a bus 320 for communication with one another. In the illustrated embodiment, a processor 335 is communicatively coupled to the bus 320 via signal line 336. A memory 337 is communicatively coupled to the bus 320 via signal line 338.

The processor 335 comprises an arithmetic logic unit, a microprocessor, a general purpose controller or some other processor array to perform computations, retrieve data stored on the memory 337, etc. Processor 335 processes data signals and may comprise various computing architectures including a complex instruction set computer (CISC) architecture, a reduced instruction set computer (RISC) architecture, or an architecture implementing a combination of instruction sets. The processing capability of the processor 335 may be limited to supporting the retrieval of data and transmission of data. The processing capability of the processor might be enough to perform more complex tasks, including various types of modulating, encoding and multiplexing. It will be obvious to one skilled in the art that other processors, operating systems, sensors, displays and physical configurations are possible.

The memory 337 is a non-transitory storage medium that stores data necessary for the transmitter module 234 to perform its function. For example, the memory 337 stores the sub-modules (communication module 301, determination module 305, etc.) of the transmitter module 234. In another example, the memory 337 stores source data received from the control unit 202 for storage or buffering. In yet another example, the memory 337 stores one or more transmission signals received from the precoding module 307 for storage or buffering.

The communication module 301 is code and routines for handling communications between components of the transmitter module 234 and other components of the communication system 103. In one embodiment, the communication module 301 is a set of instructions executable by the processor 335 to provide the functionality below for handling communications between components of the transmitter module 234 and other components of the communication system 103. In another embodiment, the communication module 301 is stored in memory 337 and is accessible and executable by the processor 335. In either embodiment, communication module 301 is adapted for communication and cooperation with the processor 335 and other components of the transmitter module 234 via signal line 322.

In one embodiment, the communication module 301 receives data from other components of the communication system 103 and delivers the data to the appropriate component of the transmitter module 234. For example, the communication module 301 receives source data from the control unit 202. The communication module 301 delivers the source data to the retrieving module 303. In another example, the communication module 301 receives shared data from the receiver module 232. The communication module 301 delivers the shared data to the determination module 305.

In another embodiment, the communication module 301 receives data from other components of the transmitter module 234 and delivers the data to the other components of the communication system 103. For example, the communication module 301 receives one or more transmission signals from the sending module 311. The communication module 301 delivers the one or more transmission signals to the antenna 110. In another example, the communication module 301 receives graphical data from the GUI module 313. The communication module 301 delivers the graphical data to the interface 212 via the control unit 202.

In yet another embodiment, the communication module 301 handles the communications between other sub-modules 303, 305, 307, 311 and 313 in the transmitter module 234. For example, the communication module 301 communicates with the precoding module 307 and the sending module 311 to pass the output of the precoding module 307 (such as one or more transmission signals) to the sending module 311. However, this description may occasionally omit mention of the communication module 301 for purposes of clarity and convenience. For example, for purposes of clarity and convenience, the above scenario may be described as the precoding module 307 passing one or more transmission signals to the sending module 311.

The retrieving module 303 is code and routines for retrieving data. In one embodiment, the retrieving module 303 is a set of instructions executable by the processor 335 to provide the functionality below for retrieving data. In another embodiment, the retrieving module 303 is stored in memory 337 and is accessible and executable by the processor 335. In either embodiment, retrieving module 303 is adapted for communication and cooperation with the processor 335 and other components of the transmitter module 234 via signal line 324.

In one embodiment, the retrieving module 303 retrieves data from the storage device 240 via the control unit 202. The retrieving module 303 sends the data to other components of the transmitter module 234. In one embodiment, the retrieving module 303 also sends the retrieved data to the memory 337 for storage or for buffering.

In one embodiment, the retrieving module 303 generates a request for source data. For example, the retrieving module 303 generates a request for source data describing the traffic information. In another example, the retrieving module 303 generates a request for source data indicating a safety warning. In one embodiment, the retrieving module 303 sends the request for source data to the control unit 202 via the communication module 301. The control unit 202 retrieves the source data from the storage device 240. In one embodiment, the control unit 202 retrieves the source data from the unified cloud database 150. The control unit 202 delivers the source data to the retrieving module 303 via the communication module 301. The retrieving module 303 sends the source data to the precoding module 307.

In one embodiment, the retrieving module 303 sends a request for source data periodically. For example, the retrieving module 303 sends a request for source data to the control unit 202 in a pre-determined time interval such as one second, five seconds, 30 seconds, one minute, five minutes, etc. In another embodiment, the retrieving module 303 receives source data when the source data is generated. For example, the control unit 202 generates source data based at least in part on one or more sensor signals from the sensor 231. The control unit 202 then sends the source data to the retrieving module 303.

The determination module 305 is code and routines for generating one or more virtual transmitting groups. In one embodiment, the determination module 305 is a set of instructions executable by the processor 335 to provide the functionality below for generating one or more virtual transmitting groups. In another embodiment, the determination module 305 is stored in memory 337 and is accessible and executable by the processor 335. In either embodiment, determination module 305 is adapted for communication and cooperation with the processor 335 and other components of the transmitter module 234 via signal line 326.

The determination module 305 receives data from the receiver module 232. In one embodiment, the determination module 305 receives the data when the data is generated by the receiver module 232. For example, the determination module 305 receives shared data when the receiver module 232 processes a shared signal from another communication system 103b and generates the shared data.

In another embodiment, the determination module 305 receives data from the receiver module 232 in response to a request. In this embodiment, the determination module 305 generates and transmits the request, for example, to another communication system 103b via the antenna 110. In response to the request, the receiver module 232 receives a shared signal from the communication system 103b. The receiver module 232 then generates shared data from the shared signal and sends the shared data to the determination module 305. In a further embodiment, the determination module 305 generates the request for data in a pre-determined time interval such as one second, one minute, five minutes, etc.

In response to receiving the data from the receiver module 232, the determination module 305 then generates one or more virtual transmitting groups if the received data meets one or more requirements of a virtual transmitting group. The one or more requirements of a virtual transmitting group are stored as group requirement data in the storage device 240. In one embodiment, in response to receiving the data from the receiver module 234, the determination module 305 instructs the retrieving module 303 to retrieve the one or more requirements from the storage device 240. In this embodiment, the retrieving module 303 retrieves the one or requirements and sends it to the determination module 305.

In one embodiment, the determination module 305 receives shared data, transmission information and signal descriptors from the receiver module 232. In this embodiment, the receiver module 232 receives a shared signal from another communication system 103b. The receiver module 232 processes the shared signal to generate the shared data, transmission information and the signal descriptors. The shared data includes, for example, data describing a traffic condition, a safety warning, a road condition, a status and/or action of a vehicle, etc. The transmission information includes data describing one or more conditions to transmit the shared data. The signal descriptors include information, for example, the signal strength of the received shared signal, the distance between the communication system 103a (that includes the determination module 305) and the communication system 103b.

In one embodiment, the determination module 305 determines whether the signal descriptors meet one or more requirements of a virtual transmitting group. For example, the determination module 305 determines whether the signal strength of the shared signal exceeds a strength threshold. In another example, the determination module 305 determines whether the distance is below a distance threshold. The strength threshold and the distance threshold are pre-determined and are stored as group requirement data in the storage device 240.

In one embodiment, the determination module 305 generates the virtual transmitting group if the signal descriptors meet the one or more requirements. The virtual transmitting group includes the communication system 103 a (that includes the determination module 305) and the communication system 103b from which the shared signal was received. The determination module 305 also assigns the communication systems 103a and 103b as participating communication systems of the virtual transmitting group. Once the virtual transmitting group is generated, the determination module 305 sends the shared data and the transmission information to the precoding module 307.

In one embodiment, the determination module 305 sends an identity of the participating communication system 103b to the storage device 240 via the control unit 202 for storage. In another embodiment the determination module 305 sends the identity of the participating communication system 103b to the memory 337 for storage or buffering. Although only two communication systems 103a, 103b are included in a virtual transmitting group, a person with ordinary skill in the art will recognize that any number of communication systems 103n can be included in a virtual transmitting group.

The precoding module 307 is code and routines for calculating one or more precoding vectors and generating one or more transmission signals. In one embodiment, the precoding module 307 is a set of instructions executable by the processor 335 to provide the functionality below for calculating one or more precoding vectors and generating one or more transmission signals. In another embodiment, the precoding module 307 is stored in memory 337 and is accessible and executable by the processor 335. In either embodiment, precoding module 307 is adapted for communication and cooperation with the processor 335 and other components of the transmitter module 234 via signal line 328.

In one embodiment, the precoding module 307 receives source data from the retrieving module 303. The precoding module 307 also receives shared data and transmission information from the determination module 305. The precoding module 307 then calculates a precoding vector describing one or more requirements for interference alignment. For example, a requirement of interference alignment is a constraint so that each interference signal will be aligned into a signal subspace that is different from the signal subspace of the desired signal at a receiving communication system 103. Thus the receiving communication system 103 can differentiate the interference signals from the desired signal and remove the interference signals.

In another embodiment, the precoding module 307 calculates the precoding vector describing one or more requirements for interference alignment based at least in part on the transmission information. The transmission information includes data describing one or more conditions for transmitting the shared data. In this embodiment the transmission information and the shared data are generated from a shared signal received from a participating communication system 103b. The participating communication system 103a (that includes the precoding module 307) and the participating communication system 103b are associated with the same virtual transmitting group. The transmission information includes, for example, weight vectors, channel propagation information, etc. The weight vector is, for example, weights describing signal spaces in which the interference signals should be aligned for a receiving communication system 103. The channel propagation information is, for example, data describing how a signal propagates from a transmitting communication system 103 to a receiving communication system 103, attenuation of signal power with distance, effects of scattering and fading, etc.

Once the precoding vector is calculated, the precoding module 307 generates a transmission signal based at least in part on the precoding vector, the source data and the shared data. In one embodiment, the precoding module 307 multiplies the precoding vector with the source data and the shared data to generate the transmission signal. Thus the transmission signal is controlled to realize interference alignment at a receiving communication system 103. The precoding module 307 then delivers the transmission signal to sending module 311. In one embodiment, the precoding module 307 also sends the transmission signal to the storage device 240 for storage via the control unit 202. In another embodiment, the precoding module 307 also sends the transmission signal to the memory 337 for storage or for buffering.

The interference signal is a type of signal (e.g., noise) that is not desired by a receiving communication system 103. For example, a receiving communication system 103 receives signals from participating communication systems 103a, 103b and 103n that are associated with a first, a second and a third virtual transmitting group respectively. The signal transmitted by participating system 103n is the desired signal for the receiving communication system 103. The signals transmitted by participating communication systems 103a and 103b are interference signals for the receiving communication system.

In this example, a requirement of interference alignment is that the signals transmitted by the participating communication systems 103a and 103b have to be aligned into the same signal subspace for the receiving communication system 103. In another example, a requirement of interference alignment is that the signals transmitted by the participating communication systems 103a and 103b have to be aligned in different signal subspaces, but are close to each other. The signals are close to each other in the sense of space distance or in the sense of correlation.

In either example, the receiving communication system 103 determines the signals received from participating communication systems 103a and 103b as interference signals. The receiving communication system 103 also determines the signal received from the participating communication system 103n as the desired signal, since it is aligned in a signal subspace different than that of the interference signals. Thus the receiving communication system 103 differentiates the interference signals from the desired signal and removes the interference signals.

Sharing information (i.e., shared data) between communication systems 103 of a virtual transmitting group and generating a transmission signal according to the requirements of interference alignment is advantageous. For example, the communication system 103a uses one or more antennas 110 of other communication systems 103n in the virtual transmitting group for transmitting information. The other communication systems 103n receive shared data from the communication system 103a. The other communication systems 103n generate the transmission signal using the shared data according to one or more requirements of interference alignment. Although three signals are described above, persons having ordinary skill in the art will recognize that in some embodiments the system 103 can be implemented so that it multiplexes a different number of signals.

The spatial multiplexing gain of the transmission signal generated in this example is higher than that of a transmission signal generated by the communication system 103a according to existing technologies. Existing technologies include, for example, cooperative multiple in multiple out, etc. The spatial multiplexing gain is higher because it is proportional to the number of antennas used for transmitting the transmission signal. Although only one advantage is mentioned above, a person with ordinary skill in the art will recognize other advantageous of a virtual transmitting group.

The sending module 311 is code and routines for sending one or more transmission signals to the antenna 110 for transmission. In one embodiment, the sending module 311 is a set of instructions executable by the processor 335 to provide the functionality below for sending one or more transmission signals to the antenna 110 for transmission. In another embodiment, the sending module 311 is stored in memory 337 and is accessible and executable by the processor 335. In either embodiment, sending module 311 is adapted for communication and cooperation with the processor 335 and other components of the transmitter module 234 via signal line 332.

In one embodiment, the sending module 311 receives a transmission signal from the precoding module 307. The sending module 311 sends the transmission signal to the antenna 110 for transmission to one or more receiving communication systems 103. In one embodiment, the sending module 311 amplifies the transmission signal and sends it to the antenna 110. For example, the sending module 311 amplifies the transmission signal using conventional amplification techniques. In one embodiment, the sending module 311 also sends an instruction including the transmission signal to the GUI module 313.

In one embodiment, the sending module 311 sends the transmission signal so that it is contemporaneously transmitted by the antenna 110, with the transmission signals of one or more participating communication systems 103n. In this embodiment, the participating communication systems 103n are associated with the same virtual transmitting group as that of the participating communication system 103a (that includes the sending module 311). For example, the participating communication system 103a (that includes the sending module 311) generates a transmission signal based at least in part on the shared data and transmission information received from a participating communication system 103b. The participating communication systems 103a and 103b are associated with the same virtual transmitting group. In this example, the sending module 311 sends the transmission signal so that it is contemporaneously transmitted by the antenna 110 with the transmission signal of the participating communication system 103b.

The GUI module 313 is code and routines for generating graphical data. In one embodiment, the GUI module 313 is a set of instructions executable by the processor 335 to provide the functionality below for generating graphical data. In another embodiment, the GUI module 313 is stored in memory 337 and is accessible and executable by the processor 335. In either embodiment, GUI module 313 is adapted for communication and cooperation with the processor 335 and other components of the transmitter module 234 via signal line 334.

In one embodiment, the GUI module 313 receives an instruction that includes the transmission signal from the sending module 311. The GUI module 313 then generates graphical data for providing a user interface that notifies a user 125 that a transmission signal including shared data and/or source data is transmitted. For example, shared data is a warning such as, “The bridge ahead is broken.” The GUI module 313 generates graphical data that provides a user interface displaying the message “A warning that the bridge ahead is broken is transmitted to the Highway Patrol Center.” The GUI module 313 sends the graphical data for providing the user interface to the interface 212 via the control unit 202. The interface 212 displays the user interface to the user 125.

In the above description, although only generating a virtual transmitting group is described, a person with ordinary skill in the art will recognize that in some embodiments, a determination module 305 of a receiving communication system 103 can similarly generate a virtual receiving group. The virtual receiving group can include one or more participating communication systems 103 that transmit and receive shared signals. For example, a participating communication system 103a of the virtual receiving group receives a shared signal transmitted by another participating communication system 103b of the virtual receiving group. The participating communication system 103a processes the shared signal and generates, for example, channel propagation information, one or more weight vector describing signal space information for receiving transmission signals, etc. The participating communication systems 103 use, for example, the channel propagation information and one or more weight vectors for differentiating a desired signal from interference signals.

### Storage Device 240

FIG. 4 is a block diagram 400 illustrating a storage device 240 according to one embodiment. The storage device 240 includes source data 401, incoming data 403, shared signal data 405, group requirement data 407 and transmission signal data 409. One skilled in the art will recognize that the storage device 240 may include other data for providing the functionality described herein.

The source data 401 is data generated by the control unit 202 based on one or more sensor signals received from the sensor 231. For example, the source data 401 includes any information that is useful to vehicles such as data describing velocity of the vehicle, steering angle of a steering device (not pictured), brake angle, a traffic condition, a safety warning, a road condition, a status and/or an action of a vehicle, etc.

The incoming data 403 is data generated by the receiver module 232 based on signals from other communication systems 103. For example, the receiver module 232 receives one or more signals from other communication systems 103. The receiver module 232 processes the one or more signals and determines usable information based on the one or more signals. The receiver module 232 generates incoming data using the usable information. The receiver module 232 stores the incoming data in the storage device 240 via the control unit 202. For example, the incoming data 403 includes one or more of a traffic condition, a safety warning, a road condition, a status and/or an action of a vehicle, etc.

The shared signal data 405 is data generated by the receiver module 232 based on shared signals from other communication systems 103. For example, the receiver module 232 of communication system 103a receives a shared signal that is transmitted by a communication system 103b. The receiver module 232 processes the shared signal to generate shared data, transmission information and signal descriptors. The shared data includes, for example, data describing a traffic condition, a safety warning, a road condition, a status and/or action of a vehicle, etc. The transmission information includes, for example, a weight vector, channel propagation information, etc. The signal descriptors include, for example, signal strength of the shared signal, etc. The storage device 240 stores the shared data, the transmission information and the signal descriptors as shared signal data 405.

The group requirement data 407 is data describing one or more requirements of a virtual transmitting group. For example, the group requirement data 407 includes a strength threshold, a distance threshold, etc.

The transmission signal data 409 includes one or more transmission signals. For example, one or more transmission signals are generated by the transmitter module 234 based on one or more precoding vectors, source data and the shared data.

### Methods

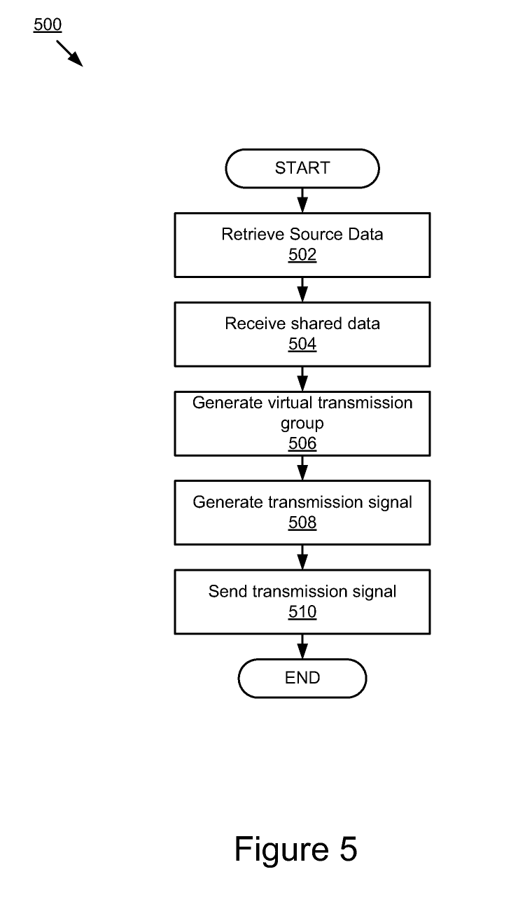

Referring now to FIGS. 5-7, various embodiments of the method of the specification will be described. FIG. 5 is a flow diagram illustrating a method 500 for generating a transmission signal according to one embodiment. At step 502, the retrieving module 303 retrieves source data. For example, the retrieving module 303 retrieves source data from the storage device 240 via the control unit 202. At step 504, the determination module 305 receives shared data. For example, the determination module 305 receives shared data from the receiver module 232. The receiver module 232 generates the shared data from a shared signal received from another communication system 103b. At step 506, the determination module 305 generates a virtual transmitting group. For example, the determination module 305 generates a virtual transmitting group including the communication system 103a (that includes the determination module 305) and the communication system 103b. At step 508, the precoding module 307 generates a transmission signal. For example, the precoding module 307 generates the transmission signal based on the source data and the shared data. At step 510, the sending module 311 sends the transmission signal. For example, the sending module 311 sends the transmission signal to one or more receiving communication systems 103, via the antenna 110.

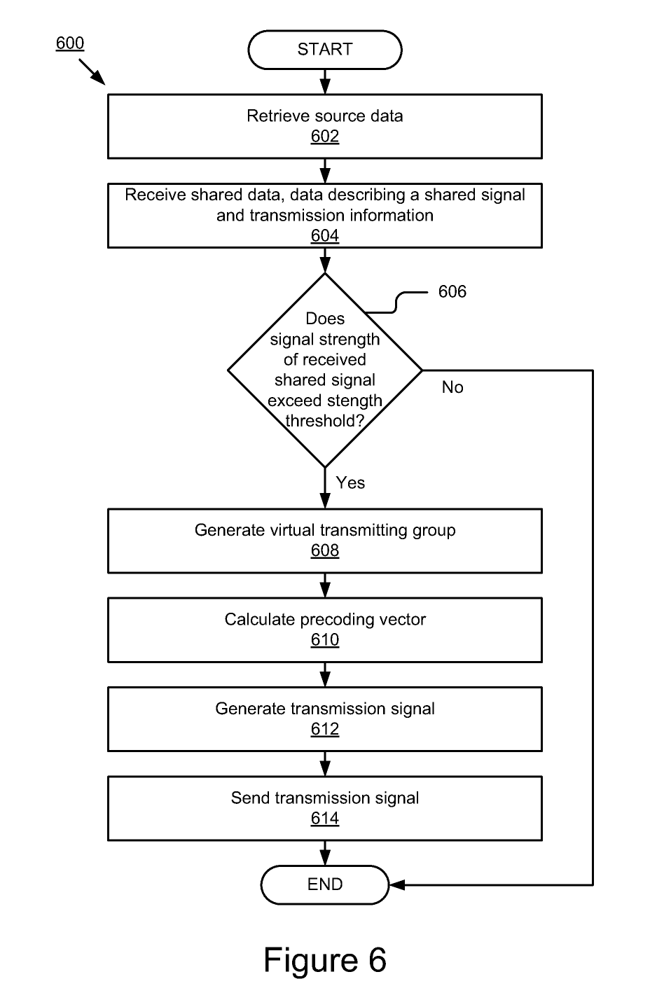

FIG. 6 is a flow diagram illustrating a method 600 for generating a transmission signal according to another embodiment. At step 602, the retrieving module 303 retrieves source data. For example, the retrieving module 303 retrieves source data from the unified cloud database 150 via the control unit 202. At step 604, the determination module 305 receives shared data, signal descriptors and transmission information. For example, the determination module 305 receives the shared data, the signal descriptors and the transmission information from the receiver module 232. The receiver module 232 generates the shared data, the signal descriptors and transmission information from the shared signal received from another communication system 103b. The signal descriptors include the signal strength of the shared signal. At step 606, the determination module 305 determines whether the signal strength of the received shared signal exceeds a strength threshold.

In one embodiment, if the determination module 305 determines that the signal strength is below the threshold, the method 600 ends. In another embodiment, if the determination module 305 determines that the signal strength exceeds the threshold, the method 600 executes step 608. At step 608, the determination module 305 generates a virtual transmitting group. For example, the determination module 305 generates a virtual transmitting group including the communication system 103a (that includes the determination module 305) and the communication system 103b.

At step 610, the precoding module 307 calculates a precoding vector. For example, the precoding module 307 calculates a precoding vector describing one or more requirements of interference alignment based at least in part on the transmission information. At step 612, the precoding module 307 generates a transmission signal. For example, the precoding module 307 generates a transmission signal based at least in part on the source data, the shared data and the precoding vector. At step 614, the sending module 311 sends the transmission signal. For example, the sending module 311 sends the transmission signal to one or more receiving communication systems 103 via the antenna 110. In another example, the sending module 311 sends the transmission signal to one or more communication systems 103 associated with a virtual receiving group.

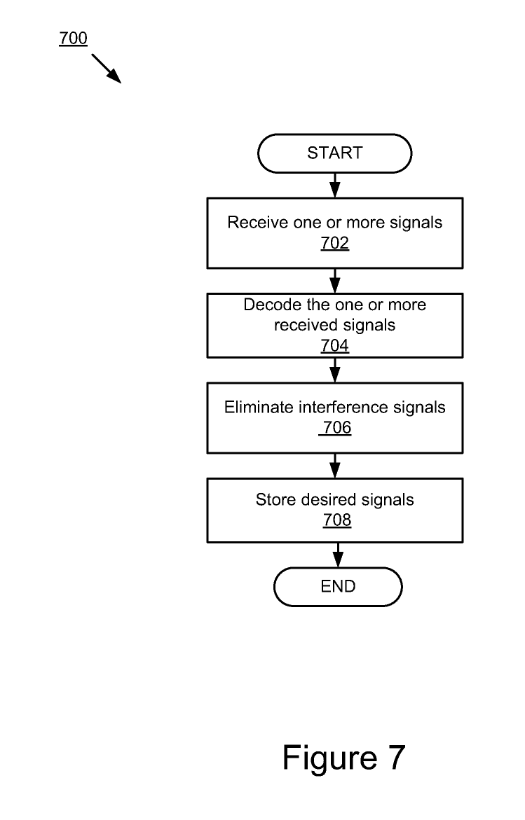

FIG. 7 is a flow diagram illustrating a method 700 for receiving transmission signals according to one embodiment. At step 702, the receiver module 232 receives one or more signals. For example, the receiver module 232 receives one or more signals from the network 105 via the antenna 110. For example, the one or more received signals are one or more transmission signals from other communication systems 103 coupled to the network 105.

At step 704, the receiver module 232 decodes the one or more signals. For example, the receiver module 232 decodes transmission signals received from other communication systems 103. The received transmission signals are generated in other communication systems 103 using precoding vectors. Therefore, the received transmission signals are aligned according to one or more requirements of interference alignment at the receiving communication system 103 (including the receiver module 232). Hence, all interference signals are in a signal subspace different from that of the desired signals.

At step 706, the receiver module 232 eliminates the interference signals. For example, the receiver module 232 eliminates the interference signals by filtering all signals in the subspace where the interference signals are. At step 708, the receiver module 232 stores the desired signals. For example, after eliminating the interference signals the receiver module 232 obtains the desired signals. The receiver module 232 then determines usable information based on the desired signals. The receiver module 232 generates incoming data using the usable information. The receiver module 232 sends the incoming data to the storage device 240 via the control unit 202. The storage device 240 stores the incoming data.

The foregoing description of the embodiments has been presented for the purposes of illustration and description. It is not intended to be exhaustive or to limit the specification to the precise form disclosed. Many modifications and variations are possible in light of the above teaching. It is intended that the scope of the embodiments be limited not by this detailed description, but rather by the claims of this application. As will be understood by those familiar with the art, the examples may be embodied in other specific forms without departing from the spirit or essential characteristics thereof. Likewise, the particular naming and division of the modules, routines, features, attributes, methodologies and other aspects are not mandatory or significant, and the mechanisms that implement the description or its features may have different names, divisions and/or formats. Furthermore, as will be apparent to one of ordinary skill in the relevant art, the modules, routines, features, attributes, methodologies and other aspects of the specification can be implemented as software, hardware, firmware or any combination of the three. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the specification is in no way limited to implementation in any specific programming language, or for any specific operating system or environment. Accordingly, the disclosure is intended to be illustrative, but not limiting, of the scope of the specification, which is set forth in the following claims.

What is claimed is:

1. A computer-implemented method for virtual interference alignment, the method comprising:
retrieving source data;
receiving shared data and transmission information, the shared data and the transmission information generated from a shared signal received from one or more participating communication systems associated with a first virtual transmitting group;
calculating a precoding vector describing one or more requirements of interference alignment based at least in part on the transmission information; and
generating a first transmission signal based at least in part on the precoding vector, the source data and the shared data.

2. The method of claim 1, further comprising sending the first transmission signal to one or more receiving communication systems, the first transmission signal aligned in a signal subspace of a second transmission signal.

3. The method of claim 2, wherein the second transmission signal is transmitted by one or more participating communication systems associated with a second virtual transmitting group.

4. The method of claim 3, wherein the first and second transmission signals are determined to be interference signals in at least one of the one or more receiving communication systems.

5. The method of claim 2, further comprising sending the first transmission signal contemporaneously with the one or more participating communication systems associated with the first virtual transmitting group to the one or more receiving communication systems.

6. The method of claim 1, wherein the transmission information includes at least one of channel propagation information and a weight vector.

7. The method of claim 1, further comprising:
determining whether a signal strength of the shared signal exceeds a strength threshold; and
generating the first virtual transmitting group including the one or more participating communication systems in response to determining that the signal strength exceeds the strength threshold.

8. The method of claim 1, wherein generating the first transmission signal further comprises multiplying the precoding vector with the source data and the shared data.

9. A system for virtual interference alignment, the system comprising:
a retrieving module retrieving source data;
a determination module communicatively coupled to the retrieving module, the determination module receiving shared data and transmission information, wherein the shared data and the transmission information are generated from a shared signal received from one or more participating communication systems associated with a first virtual transmitting group; and
a precoding module communicatively coupled to the determination module and the retrieving module, the precoding module calculating a precoding vector describing one or more requirements of interference alignment based at least in part on the transmission information and generating a first transmission signal based at least in part on the precoding vector, the source data and the shared data.

10. The system of claim 9, further comprising a sending module communicatively coupled to the precoding module, the sending module sending the first transmission signal to one or more receiving communication systems, wherein the first transmission signal is aligned in a signal subspace of a second transmission signal.

11. The system of claim 10, wherein the second transmission signal is transmitted by one or more participating communication systems associated with a second virtual transmitting group.

12. The system of claim 11, wherein the first and second transmission signals are determined to be interference signals in at least one of the one or more receiving communication systems.

13. The system of claim 10, wherein the sending module further sends the first transmission signal contemporaneously with the one or more participating communication systems associated with the first virtual transmitting group to the one or more receiving communication systems.

14. The system of claim 9, wherein the determination module further determines whether a signal strength of the shared signal exceeds a strength threshold and generates the first virtual transmitting group including the one or more participating communication systems in response to determining that the signal strength exceeds the strength threshold.

15. A computer program product comprising a non-transitory computer readable medium encoding instructions that, in response to execution by a computing device, cause the computing device to perform operations comprising:
retrieving source data;
receiving shared data and transmission information, the shared data and the transmission information generated from a shared signal received from one or more participating communication systems associated with a first virtual transmitting group;
calculating a precoding vector describing one or more requirements of interference alignment based at least in part on the transmission information; and
generating a first transmission signal based at least in part on the precoding vector, the source data and the shared data.

16. The computer program product of claim 15, further causing the computing device to perform operations comprising sending the first transmission signal to one or more receiving communication systems, the first transmission signal aligned in a signal subspace of a second transmission signal.

17. The computer program product claim of 16, wherein the second transmission signal is transmitted by one or more participating communication systems associated with a second virtual transmitting group.

18. The computer program product of claim 17, wherein the first and second transmission signals are determined to be interference signals in at least one of the one or more receiving communication systems.

19. The computer program product of claim 16, further causing the computing device to perform operations comprising sending the first transmission signal contemporaneously with the one or more participating communication systems associated with the first virtual transmitting group to the one or more receiving communication systems.

20. The computer program product of claim 15, further causing the computing device to perform operations comprising:
determining whether a signal strength of the shared signal exceeds a strength threshold; and
generating the first virtual transmitting group including the one or more participating communication systems in response to determining that the signal strength exceeds the strength threshold.
